(19) United States
(12) Patent Application Publication
(10) Pub. No.: US 2008/0271376 A1
(43) Pub. Date: Nov. 6, 2008

(54) FUEL REFORMER SYSTEM AND A METHOD FOR OPERATING THE SAME

(75) Inventors: Joel Meier Haynes, Clifton Park, NY (US); Jeffrey Scott Goldmeer, Latham, NY (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: GENERAL ELECTRIC COMPANY, Schenectady, NY (US)

(21) Appl. No.: 11/742,599

(22) Filed: May 1, 2007

(51) Int. Cl. C01B 3/32

(52) U.S. Cl. 48/127.3; 48/127.9

(57) ABSTRACT

A natural gas reformer system is provided. The natural gas reformer system includes a natural gas inlet configured to receive a natural gas slipstream. The natural gas reformer system also includes an air inlet configured to introduce a slip stream of air. The natural gas reformer system further includes a preconditioning zone configured to pretreat the natural gas slipstream. The natural gas reformer system also includes a mixing zone configured to mix the natural gas slipstream and the air in a rich proportion. The natural gas reformer system further includes a reaction zone configured to combust the natural gas and air to generate a syngas. The natural gas reformer system also includes a quench zone configured to mix the natural gas back into the syngas.

### BACKGROUND

The invention relates generally to fuel reformer systems and, more particularly, to fuel reformer systems for gas turbines.

Fuel injection and mixing are critical to achieving efficient and clean combustion in gas turbine engines. In case of gaseous fuels, it is desirable to obtain an optimal level of mixing between air, fuel, and combustion products in a combustion zone.

Exhaust gases from gas turbine engines contain substances such as Nitrogen Oxides (NOx) that are harmful regulated emissions. Hence, there has been increased demand in recent years for gas turbines that operate in partially premixed (PP) or lean, premixed (LP) mode of combustion in an effort to meet increasingly stringent emissions goals. Partially premixed (PP) and lean premixed combustion reduces harmful emission of Nitrogen Oxides without loss of combustion efficiency.

However, combustion instabilities, also known as combustion dynamics, are commonly encountered in development of low emissions gas turbine engines. Combustion dynamics in the form of fluctuations in pressure, heat-release rate, and other perturbations in flow may lead to problems such as structural vibration, excessive heat transfer to a chamber, and consequently lead to failure of the system.

Reforming the fuel is a solution to reduce combustion dynamics. One method employs a rich catalytic system to reform the fuel just prior to combustion and is further integrated into the combustion chamber. However, such a technique requires catalysts that have substantially high capital and operating costs.

Therefore, a need exists for an improved fuel reforming system for controlling combustion dynamics that may address one or more of the problems set forth above.

### BRIEF DESCRIPTION

In accordance with one aspect of the invention, a natural gas reformer system is provided. The natural gas reformer system includes a natural gas inlet configured to receive a natural gas slipstream. The natural gas reformer system also includes an air inlet configured to introduce a slip stream of air. The natural gas reformer system also includes a preconditioning zone configured to pretreat the natural gas slipstream. The natural gas reformer system further includes a mixing zone configured to mix the natural gas slipstream and the air in a rich proportion. The natural gas reformer system also includes a reaction zone configured to combust the natural gas and air to generate a syngas. The natural gas reformer system further includes a quench zone configured to mix the natural gas back into the syngas.

In accordance with another aspect of the invention, a method of operating a fuel reformer system is provided. The method includes introducing a slipstream of natural gas. The method also includes introducing a slipstream of air. The method further includes preconditioning the slipstream of natural gas. The method also includes mixing the natural gas and the air in a rich proportion a mixing zone. The method also includes reacting the natural gas and air in the reaction zone, to form a syngas. The method further includes quenching the syngas leaving the reaction zone with the natural gas.

In accordance with another aspect of the invention, a retrofit unit for a gas turbine is provided. The retrofit unit includes a natural gas inlet configured to receive a natural gas slipstream. The retrofit unit also includes an air inlet configured to introduce a slipstream of air. The retrofit unit further includes a preconditioning zone configured to pretreat the natural gas slipstream. The retrofit unit also includes a mixing zone configured to mix the natural gas slipstream and the air in a rich proportion. The retrofit unit also includes a reaction zone configured to combust the natural gas slipstream and air to generate a syngas. The retrofit unit further includes a quench zone configured to mix the natural gas back into the syngas.

### DRAWINGS

These and other features, aspects, and advantages of the present invention will become better understood when the following detailed description is read with reference to the accompanying drawings in which like characters represent like parts throughout the drawings, wherein:

FIG. 1 is a block diagram representation of a fuel reformer system in accordance with an embodiment of the invention;

FIG. 2 is a block diagram representation of a regulated fuel reformer system in accordance with an embodiment of the invention;

FIG. 3 is a block diagram representation of a regulated fuel reformer system including a heat exchanger in accordance with an embodiment of the invention;

FIG. 4 is a block diagram representation of a regulated fuel reformer system including a carbon capture system in accordance with an embodiment of the invention;

FIG. 5 is a schematic illustration of mixing and reaction zones of a fuel reformer system employing effusion cooling mechanism;

FIG. 6 is a schematic illustration of mixing and reaction zones of a fuel reformer system employing an impingement cooling mechanism;

FIG. 7 is a schematic illustration of mixing and reaction zones of a fuel reformer system including a ceramic liner; and

FIG. 8 is a flow chart representing steps involved in an exemplary method for operating a fuel reformer system.

### DETAILED DESCRIPTION

As described in detail below, embodiments of the present invention provide a fuel reformer system and a method for providing the same. The system includes mixing and reacting a slipstream of natural gas or fuel with a slipstream of air to increase concentration of hydrogen. The introduction of hydrogen into the natural gas allows lowering of a lean blow out point and enables reduction in combustion dynamics. The term “combustion dynamics” used herein refers to fluctuations in air pressure, temperature, heat release and unsteady flow oscillations that effect operation of an engine, including a gas turbine. Further, the term ‘lean blow out point’ used herein refers to a point of loss of combustion in a combustor. Variations in fuel composition and flow disturbances result in a loss of combustion in sufficiently lean flames. It is hence desirable to operate systems with a highly reactive fuel component, such as hydrogen. As disclosed herein, embodiments of the invention include a fuel reforming retrofit unit that provides pretreatment of fuel via means of combustion.

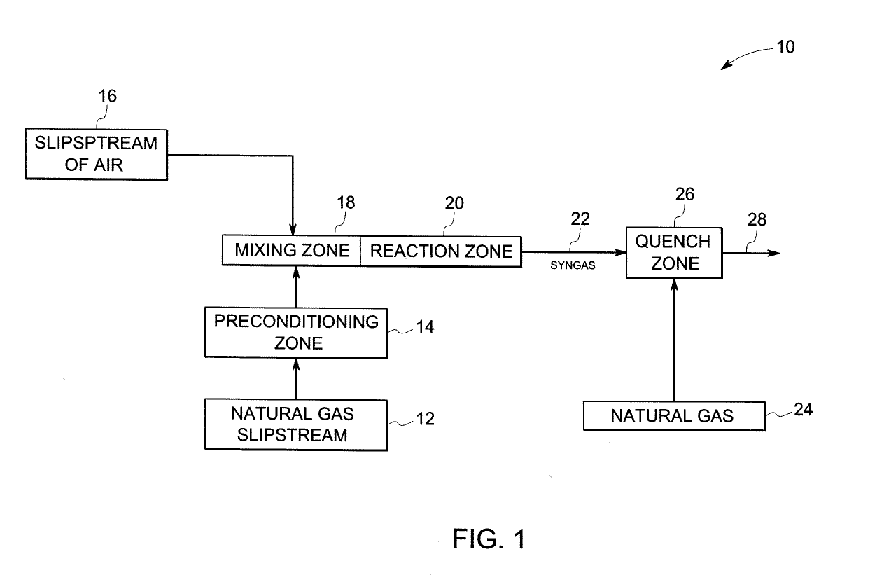

Turning to the drawings, FIG. 1 is a block diagram representation of a fuel reformer system 10. The fuel reformer system 10 includes a natural gas slipstream 12 that is pretreated in a preconditioning zone 14. In a particular embodiment, the natural gas slipstream 12 is pre-mixed with water or steam. In another embodiment, the preconditioning zone 14 includes a natural gas swirler. In yet another embodiment, the swirler includes oxidant injection orifices on an outer wall or an inner wall of duct. In another embodiment, the swirler includes oxidant injection orifices in multiple vanes. A slipstream of air 16 is introduced to mix with the natural gas slipstream 12 that are mixed in a mixing zone 18 in rich proportions. As used herein, the term “rich proportions” refers to a stoichiometric ratio of the natural gas 12 and the air 16 of between about 1.5 and about 4. In an exemplary embodiment, the stoichiometric ratio of the natural gas 12 and the air 16 is about 2.3. In a particular embodiment, the slipstream of air 16 is supplemented with oxygen.

Further, the natural gas 12 and the slipstream of air 16 are allowed to react in a reaction zone 20 to generate a gaseous mixture of synthesis gas 22, commonly known as syngas, which typically consists of hydrogen and carbon monoxide. In a particular embodiment, the syngas includes at least about 20 percent of hydrogen gas. In another embodiment, the synthetic gas includes at least one hydrocarbon species. In yet another embodiment, the syngas includes hydrogen, carbon monoxide, nitrogen and water. In another embodiment, the syngas 22 has a temperature less than about 2000 degrees Fahrenheit. In a presently contemplated embodiment, the reaction zone 20 has a residence time of less than about 200 ms. The term “residence time” refers to a time period during which the natural gas 12 and the air 16 react in the reaction zone 20. A natural gas supply 24 is finally directed back into a quench zone 26 to mix with the syngas 22 leaving the reaction zone 20. A mixture 28 of the natural gas 24 and the syngas 22 is further directed into a downstream system such as, but not limited to, a combustor. In a particular embodiment, the fuel reformer system 10 includes an area equal to about 1/10 th to about 1/80 th of an area of a combustion system.

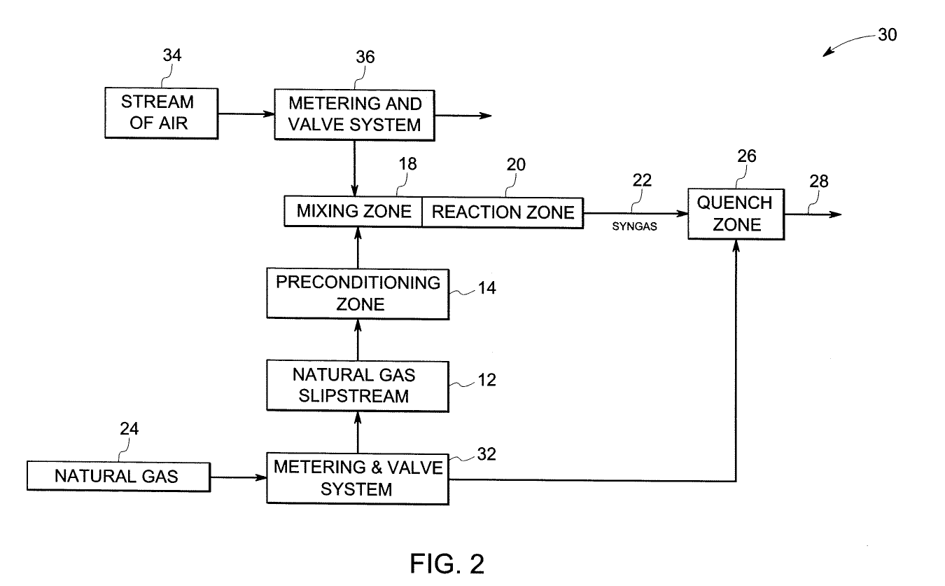

In another illustrated embodiment of the invention as shown in FIG. 2, a block diagram representation of a regulated fuel reformer system 30 is depicted. The fuel reformer system 30 includes a natural gas supply 24, as referenced in FIG. 1 that is controlled by a metering and valve system 32 to generate a natural gas slipstream 12 that is passed into the preconditioning zone 14, as referenced in FIG. 1. Similarly, a stream of air 34 is passed through a metering and valve system 36 to generate a slipstream of air 16, as referenced in FIG. 1. The slipstream of air 16 and the natural gas slipstream 12 are mixed in the mixing zone 18 and allowed to react in the reaction zone 20. The natural gas supply 24 regulated by the metering and valve system 32 may also be directed into the quench zone 26 to mix with the syngas 22 leaving the reaction zone 20.

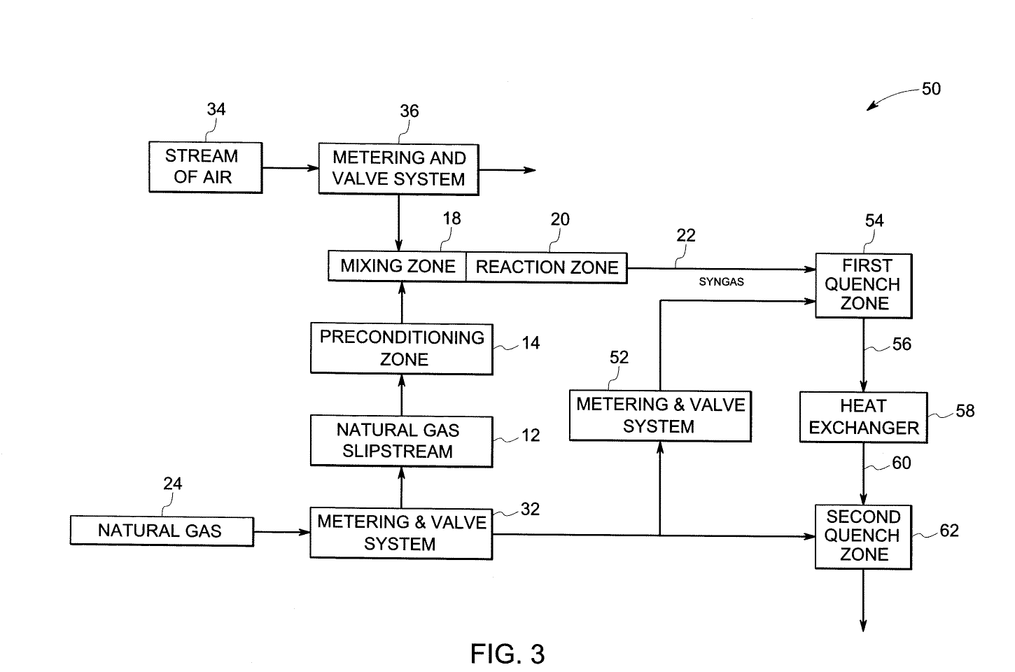

In yet another illustrated embodiment of the invention as shown in FIG. 3, a block diagram representation of a fuel reformer system 50 is depicted. The fuel reformer system 50 includes a natural gas slipstream 12, as referenced in FIG. 1 and a slip stream of air 16 passed into a mixing zone 18 and a reaction zone 20, thereby generating a syngas 22. The natural gas 24 is regulated by a metering and valve system 32, as referenced in FIG. 2, and directed into another metering and valve system 52 before passing into a first quench zone 54. The natural gas 24 and the syngas 22 are mixed in the first quench zone 54 to form a syngas mixture 56. The syngas mixture 56 is directed into a heat exchanger 58 that enables cooling of the syngas mixture 56. A cooled syngas mixture 60 from the heat exchanger 58 is further directed into a second quench zone 62, wherein the cooled syngas mixture 60 is quenched by the natural gas 24.

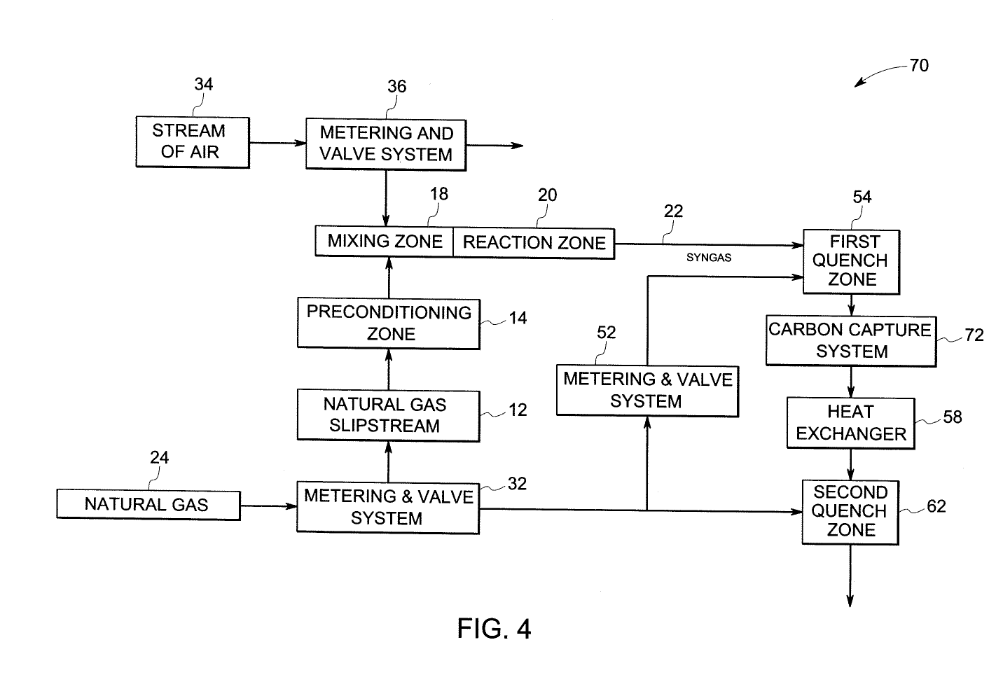

FIG. 4 is a block diagram representation of a fuel reformer system 70 including a carbon capture system 72. After mixing a natural gas slipstream 12 and a slip stream of air 16 in the mixing zone 18 and reacting the mixture in the reaction zone 20, a syngas 22 is passed into a first quench zone 54, as referenced in FIG. 3, to quench the natural gas 24. The syngas mixture 56 in FIG. 3 is passed through the carbon capture system 72. The carbon capture system 72 reduces the amount of carbon monoxide from the syngas mixture 56 resulting in a refined mixture. The mixture is further passed into a heat exchanger 58, as referenced in FIG. 3. A cooled syngas mixture 60, as referenced in FIG. 3, from the heat exchanger 58 is then directed into a second quench zone 62, as referenced in FIG. 3, to quench the syngas mixture 60.

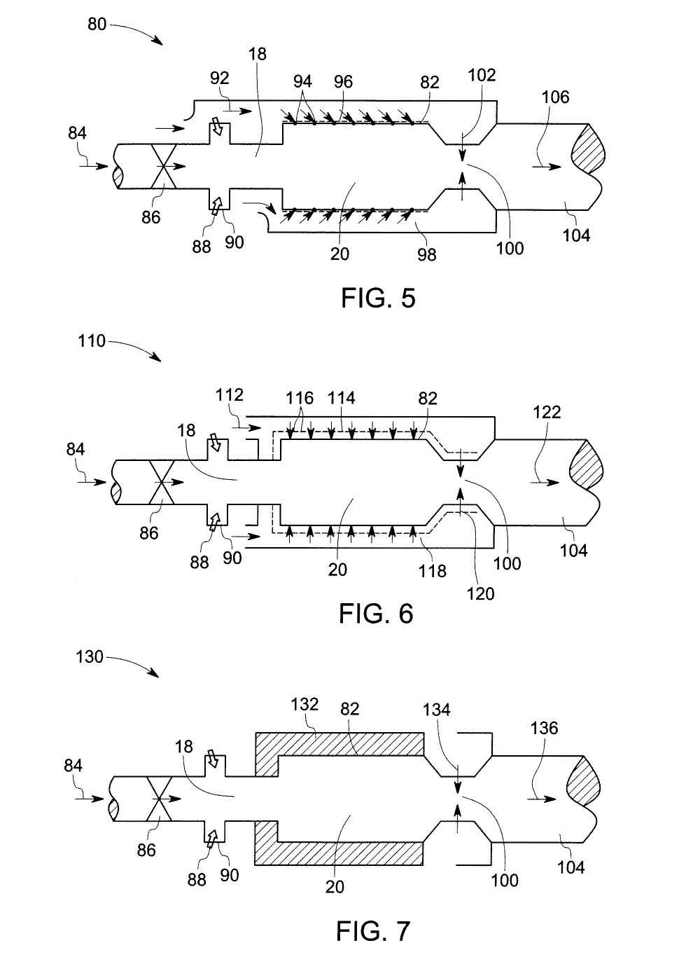

FIGS. 5 and 6 illustrate various cooling mechanisms that may be employed in the fuel reformer system 10 in FIG. 1. FIG. 5 is a schematic illustration of a fuel reformer system 80 employing effusion cooling through natural gas to extract heat from walls 82 of a reaction zone 20 as referenced in FIG. 1. A natural gas slipstream 84 passing through an inlet 86 mixes with a slipstream of air 88 entering through an inlet 90 in a mixing zone 18 as referenced in FIG. 1. Multiple jets 92 of natural gas are injected into injection holes 94 on a wall liner 96 in a confined space 98. A mixture of syngas is formed at the reaction zone 20 and passes through a quench 100 that provides rapid cooling prior to mixing with a stream 102 of natural gas and entering a downstream system such as, but not limited to, a combustion chamber 104. A cooled syngas mixture 106 further enters the combustion chamber 104.

FIG. 6 is a schematic illustration of a fuel reformer system 110 employing impingement cooling through natural gas to extract heat from walls 82 as referenced in FIG. 5 of a reaction zone 20 as referenced in FIG. 1. A natural gas slipstream 84, as referenced in FIG. 5, passing through an inlet 86 mixes with a slipstream of air 88 entering through an inlet 90 in a mixing zone 18 as referenced in FIG. 1. Multiple jets 112 of natural gas at a very high velocity are impinged on a wall liner 114 through multiple cooling holes 116 in a confined space 118. In a particular embodiment, the velocity may vary between about 10 m/sec to about 100 m/sec. A syngas is formed at the reaction zone 20 and passes through a quench 100 that provides rapid cooling prior to mixing with a stream 120 of natural gas and entering a combustion chamber 104, as referenced in FIG. 5. A cooled syngas mixture 122 further enters into the combustion chamber 104.

FIG. 7 is a schematic illustration of a fuel reformer system 130 employing a ceramic liner 132 outside of walls 82 as referenced in FIG. 5 of a reaction zone 20 as referenced in FIG. 1. A slip stream of natural gas 84 passing through an inlet 86 pre-mixes with a slip stream of air 88 entering through an inlet 90 in a mixing zone 18 as referenced in FIG. 1. A syngas mixture is formed at the reaction zone 20 and passes through a quench 100 that provides rapid cooling prior to mixing with a stream 134 of natural gas and entering a combustion chamber 104 as referenced in FIG. 5. A cooled mixture 136 further enters into the combustion chamber 104. The ceramic liner 132 provides desirable resistance against corrosion and high temperatures.

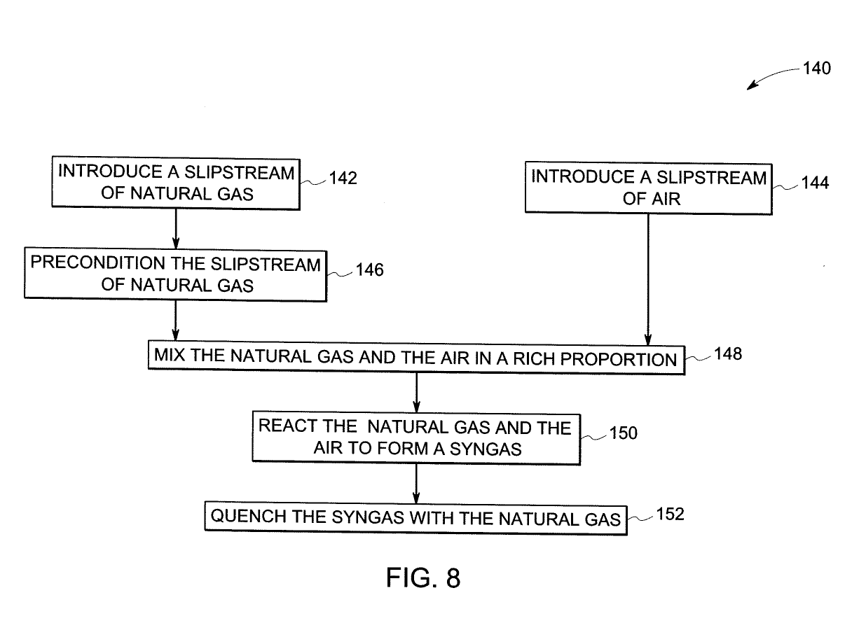

FIG. 8 is a flow chart representing steps involved in an exemplary method 140 of operation of a fuel reformer system. The method 140 includes introducing a slipstream of natural gas in step 142. A slipstream of air is introduced in step 144. The natural gas is preconditioned in a preconditioning zone in step 146. In a particular embodiment, the natural gas is preconditioned using a swirler. Preconditioned natural gas and air are mixed in a rich proportion in a mixing zone in step 148. In a particular embodiment, a stoichiometric ratio of the natural gas and the air is between about 1.5 and about 4. In an exemplary embodiment, the stoichiometric ratio of the natural gas and the air is about 2.3. Further, the natural gas and the air are allowed to react in a reaction zone forming a syngas in step 150. The natural gas is quenched with the syngas leaving the reaction zone in step 152. In a particular embodiment, a metering and valve system is employed to regulate flow of the natural gas being introduced. In another embodiment, the natural gas is directed into the syngas via multiple injection holes in the reaction zone.

The various embodiments of a fuel reformer system for lowering of a lean blow out point as well as controlling combustion dynamics and a method for operating the same described above thus provide a way to achieve a sustained lean, premixed or partially premixed flame in the combustor without lean blow-out or combustion dynamics. These techniques and systems also allow for highly efficient gas turbine engines with a fuel reformer retrofit unit due to improved combustion in their respective combustors.

Of course, it is to be understood that not necessarily all such objects or advantages described above may be achieved in accordance with any particular embodiment. Thus, for example, those skilled in the art will recognize that the systems and techniques described herein may be embodied or carried out in a manner that achieves or optimizes one advantage or group of advantages as taught herein without necessarily achieving other objects or advantages as may be taught or suggested herein.

Furthermore, the skilled artisan will recognize the interchangeability of various features from different embodiments. For example, an effusion cooling mechanism described with respect to one embodiment can be adapted for use with a carbon capture system described with respect to another. Similarly, the various features described, as well as other known equivalents for each feature, can be mixed and matched by one of ordinary skill in this art to construct additional systems and techniques in accordance with principles of this disclosure.

While only certain features of the invention have been illustrated and described herein, modifications and changes will occur to those skilled in the art. It is, therefore, to be understood that the appended claims are intended to cover all such modifications and changes as fall within the true spirit of the invention.

1. A natural gas reformer system comprising:
a natural gas inlet configured to receive a natural gas slipstream;
an air inlet configured to introduce a slip stream of air;
a preconditioning zone configured to pretreat the natural gas slipstream;
a mixing zone configured to mix the natural gas slipstream and the air in a rich proportion;
a reaction zone configured to combust the natural gas and air to generate a syngas; and
a quench zone configured to mix the natural gas back into the syngas.

2. The system of claim 1, wherein the natural gas is pre-mixed with water or steam.

3. The system of claim 1, wherein the slipstream of air is supplemented with oxygen.

4. The system of claim 1, wherein the preconditioning zone comprises a natural gas swirler.

5. The system of claim 4, wherein swirler comprises oxidant injection orifices on an outer wall or an inner wall of a duct.

6. The system of claim 4, wherein the swirler comprises oxidant injection orifices in a plurality of vanes.

7. The system of claim 1, wherein the syngas comprises at least about 20 percent of hydrogen.

8. The system of claim 1, wherein the syngas comprises at least one hydrocarbon species.

9. The system of claim 1, wherein the syngas comprises hydrogen, carbon monoxide, carbon dioxide, nitrogen, and water.

10. The system of claim 1, further comprising at least one valve to control amount of the natural gas flowing into the mixing zone and the quench zone.

11. The system of claim 1, further comprising at least one valve to control the slipstream of air flowing into the mixing zone and the reaction zone.

12. The system of claim 1, further comprising a heat exchanger to cool the syngas.

13. The system of claim 1, further comprising a carbon capture system to eliminate carbon monoxide and carbon dioxide from the syngas.

14. The system of claim 1, wherein the syngas comprises a temperature less than about 2000 degrees Fahrenheit.

15. The system of claim 1, wherein the reaction zone has a residence time of less then 200 miliseconds.

16. The system of claim 1, wherein the rich proportion comprises a stoichiometric ratio of the natural gas and the air between about 1.5 and about 4.

17. The system of claim 1, wherein the rich proportion comprises a stoichiometric ratio of the natural gas and the air of about 2.3.

18. The system of claim 1, wherein a plurality of walls of the reaction zone are effusion cooled by a plurality of injection holes directing the natural gas through the plurality of walls .

19. The system of claim 1, wherein a plurality of walls of the reaction zone are cooled by backside impingment of natural gas onto a surface at the backside.

20. The system of claim 1, wherein a plurality of injection holes direct natural gas into the syngas in the quench zone.

21. The system of claim 1, the system comprising an area equal to about 1/10 to 1/80 th of the area of a combustion system.

22. A method of operating a fuel reformer system comprising:
introducing a slipstream of natural gas;
introducing a slipstream of air;
preconditioning the slipstream of natural gas;
mixing the natural gas and the air in a rich proportion in a mixing zone;
reacting the natural gas and air in the reaction zone, to form a syngas; and
quenching the syngas leaving the reaction zone with the natural gas.

23. The method of claim 22, wherein the preconditioning comprises swirling the slipstream of natural gas.

24. The method of claim 22, wherein the mixing in a rich proportion comprises maintaining a stoichiometric ratio of the natural gas and the air between about 1.5 and about 4.

25. The method of claim 22, wherein the mixing in a rich proportion comprises maintaining a stoichiometric ratio of the natural gas and the air at about 2.3.

26. The method of claim 22, wherein the quenching comprises directing the natural gas into the syngas via a plurality of injection holes following the reaction zone.

27. The method of claim 22, wherein the quenching comprises controlling a natural gas stream mixing with the syngas via a plurality of control valves.

28. A retrofit unit for a gas turbine comprising:
a natural gas inlet configured to receive a natural gas slipstream;
an air inlet configured to introduce a slip stream of air;
a preconditioning zone configured to pretreat the natural gas slipstream;
a mixing zone configured to mix the natural gas slipstream and the air in a rich proportion;
a reaction zone configured to combust the natural gas slipstream and air to generate a syngas; and
a quench zone configured to mix the natural gas back into syngas.

29. The retrofit unit of claim 28, wherein the hydrogen rich natural gas comprises at least about 20 percent of hydrogen.

30. The retrofit unit of claim 28, further comprising at least one valve to control amount of the natural gas flowing into the reaction zone.

31. The retrofit unit of claim 28, wherein the syngas comprises at least one hydrocarbon species.

32. The retrofit unit of claim 28, wherein the syngas comprises hydrogen, carbon monoxide, carbon dioxide, nitrogen, and water vapor.

33. The retrofit unit of claim 28, further comprising a heat exchanger to cool the syngas.

34. The retrofit unit of claim 28, further comprising a carbon capture system to eliminate carbon monoxide and carbon dioxide from the syngas.

35. The retrofit unit of claim 28, wherein the syngas comprises a temperature less than about 2000 degrees Fahrenheit.

36. The retrofit unit of claim 28, wherein the reaction zone has a residence time of less than 200 miliseconds.

37. The retrofit unit of claim 28, wherein the rich proportion comprises a stoichometric ratio of natural gas slipstream and air between about 1.5 and about 4.

38. The retrofit unit of claim 28, wherein the rich proportion comprises a stoichiometric ratio of the natural gas slipstream and the air of about 2.4.

39. The retrofit unit of claim 28, wherein a plurality of walls of the reaction zone are effusion cooled by a plurality of injection holes to direct the natural gas through the plurality of walls.

40. The retrofit unit of claim 28, wherein a plurality of walls of the reaction zone are cooled by backside impingment of the natural gas onto a surface.

41. The retrofit unit of claim 28, the system comprising an area equal to about 1/10 to 1/80 th of an area of a combustion system.
